(19) United States
(12) Patent Application Publication
(10) Pub. No.: US 2025/0362841 A1
(43) Pub. Date: Nov. 27, 2025

(54) INFORMATION PROCESSING APPARATUS AND METHOD

(71) Applicant: CANON KABUSHIKI KAISHA, Tokyo (JP)

(72) Inventor: TSUYOSHI MUTO, Ibaraki (JP)

(21) Appl. No.: 19/212,484

(22) Filed: May 19, 2025

(30) Foreign Application Priority Data
May 24, 2024 (JP) 2024-084792

(51) Int. Cl. G06F 3/12

(52) U.S. Cl. CPC G06F 3/121; G06F 3/1234

(57) ABSTRACT

An information processing apparatus includes a display, one or more memories storing instructions, and one or more processors capable of executing the instructions causing the information processing apparatus to receive a selection of a diagnostic subject, display, on the display, at least one piece of job information based on the received diagnostic subject from a plurality of pieces of job related to jobs executed by the information processing apparatus, receive a designation based on the at least one piece of job information displayed, and perform a diagnosis of the information processing apparatus using the received diagnostic subject and a piece of job information corresponding to the designation.

### BACKGROUND OF THE DISCLOSURE

### Field of the Disclosure

The present disclosure relates to a method for accurately diagnosing trouble in a print job in an information processing apparatus.

### Description of the Related Art

When a job is executed using an information processing apparatus, such as a multifunction peripheral (MFP), errors may occur. For example, in the case of an MFP, an error may occur during printing, or even if a print job is executed successfully, the output may not match the user's expectations. In this way, printing trouble may arise. When such issues occur, users typically refer to product manuals or troubleshooting guides to find a solution. If they are unable to resolve issues on their own, they may contact a call center or request a service technician to solve the issues.

While users are waiting for a response from a call center or for a service technician to arrive, the information processing apparatus, such as an MFP, cannot be used normally. Thus, enabling users to resolve issues on their own is desirable to reduce the period during which the apparatus is not functioning properly.

Thus, techniques such as the one discussed in Japanese Patent Application Laid-Open No. 2012-163805 have been discussed, which present corrective action candidates based on the state of the apparatus to restore normal operation.

As described above, in order to minimize the period during which an information processing apparatus is not functioning properly, it has been proposed to equip the information processing apparatus with a diagnostic function.

For the diagnostic function of an information processing apparatus, a method has been proposed in which users select a diagnostic subject and specify the job for which trouble has occurred, and a diagnosis regarding the selected subject and job is performed.

When using the above diagnostic function, users may try to select a job, but it can take time to find the job they want to diagnose, or they may not be able to find the job at all.

### SUMMARY OF THE DISCLOSURE

According to an aspect of the present disclosure, an information processing apparatus includes a display, one or more memories storing instructions, and one or more processors capable of executing the instructions causing the information processing apparatus to receive a selection of a diagnostic subject, display, on the display, at least one piece of job information based on the received diagnostic subject from a plurality of pieces of information related to jobs executed by the information processing apparatus, receive a designation based on the at least one piece of job information displayed, and perform a diagnosis of the information processing apparatus using the received diagnostic subject and a piece of job information corresponding to the designation.

Further features of the present disclosure will become apparent from the following description of exemplary embodiments with reference to the attached drawings.

### BRIEF DESCRIPTION OF THE DRAWINGS

FIG. 1 is a block diagram illustrating an example of a hardware configuration of an image forming apparatus according to an exemplary embodiment.

FIG. 2 is a block diagram illustrating an example of a software configuration of the image forming apparatus.

FIG. 3 is a flowchart of a process for storing job information in job history during printing.

FIG. 4 is a diagram illustrating an example of the job history.

FIG. 5 is a diagram illustrating an example of a screen on which the job history is displayed.

FIG. 6 is a diagram illustrating an example of a screen of a top menu for performing trouble diagnosis on a job.

FIG. 7 is a flowchart of a process for displaying candidate jobs for a printing trouble.

FIG. 8 is a diagram illustrating an example of a screen on which candidate jobs for a printing trouble are displayed.

FIG. 9 is an example of a flowchart of a process for extracting a candidate job for a printing trouble.

FIG. 10 is an example of a flowchart of a process for extracting a candidate job for a printing trouble.

FIG. 11 is a diagram illustrating an example of a screen on which candidate jobs for a printing trouble are displayed.

FIG. 12 is an example of a flowchart of a process for extracting a candidate job for a printing trouble.

FIG. 13 is an example of a flowchart of a diagnosis process to be performed on a candidate job for a printing trouble.

FIG. 14 is a diagram illustrating an example of a corrective action list for print troubles.

FIG. 15 is a diagram illustrating an example of a screen on which a corrective action candidate list for a printing trouble is displayed.

FIG. 16 is a diagram illustrating an example of a screen displaying detailed information about a corrective action for a print trouble.

### DESCRIPTION OF THE EMBODIMENTS

An exemplary embodiment of the present disclosure will be described with reference to the accompanying drawings.

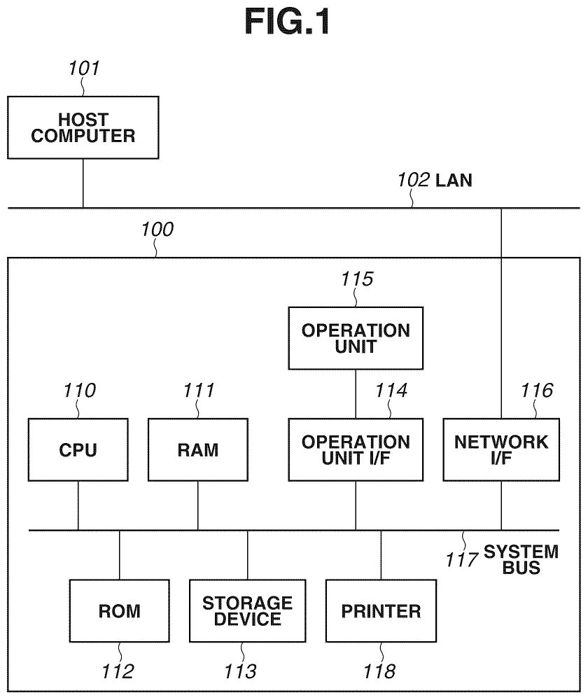

FIG. 1 is a diagram illustrating an example of a configuration of a printing system. In the printing system of the present exemplary embodiment, a host computer 101 and an image forming apparatus 100, as an example of an information processing apparatus, are connected via a local area network (LAN) 102. The image forming apparatus 100 can communicate with other communication apparatuses via the LAN 102. A user generates print data in the host computer 101 and transmits the print data from the host computer 101 to the image forming apparatus 100 via the LAN 102. The image forming apparatus 100 according to the present exemplary embodiment may be either a multifunction peripheral (MFP) or a single function printer (SFP). A printer having a plurality of functions, such as facsimile (FAX), copy, print, and scan functions, is called an MFP, and a printer having only a print function is called an SFP.

### Hardware Configuration of Image Forming Apparatus

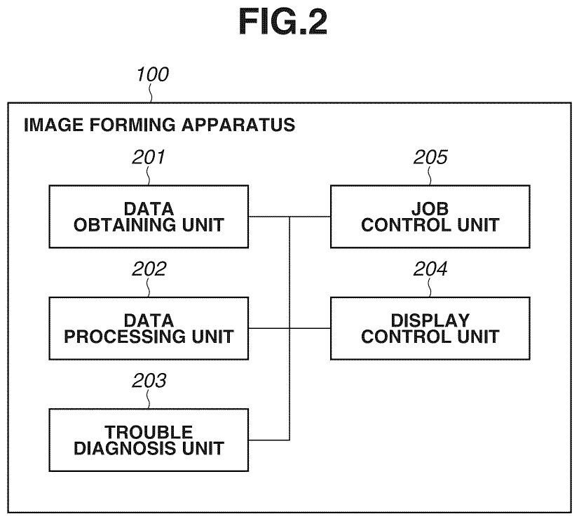

An example of a hardware configuration of an image forming apparatus 100 according to the exemplary embodiment will be described with reference to FIG. 1. A central processing unit (CPU) 110 is a control center of the image forming apparatus 100 that performs overall control of the components connected to a system bus 117. A random access memory (RAM) 111 is a storage device accessible by the CPU 110, and is used as a working memory for the CPU 110 to operate with, in the present exemplary embodiment. A read-only memory (ROM) 112 stores programs. The CPU 110 loads the programs into the RAM 111 and executes the programs to operate the corresponding software modules illustrated in FIG. 2, which will be described below. A storage unit 113 is, for example, a hard disk drive, and stores system software for various processes, obtained print data, and other types of data. An operation unit interface (I/F) 114 is an interface unit for an operation unit 115 including a display device for displaying various menus, information about print data designated for printing, and other types of information. The operation unit I/F 114 outputs operation screen data to the operation unit 115. The operation unit I/F 114 transmits information input by the user via the operation unit 115 to the CPU 110. A network I/F 116 is used for exchanging information with an external apparatus (e.g., the host computer 101) via the LAN 102. In the present exemplary embodiment, it is assumed that Page Description Language (PDL) data is received as print data from an external apparatus. A printer 118 is a print engine that performs printing on recording media, such as sheets, in accordance with the PDL data interpreted by the CPU 110.

FIG. 2 is a diagram illustrating an example of a software configuration of the image forming apparatus 100. The image forming apparatus 100 includes software modules illustrated in FIG. 2. As described above, the CPU 110 executes the programs loaded from the ROM 112 into the RAM 111 to operate the corresponding software modules.

A data obtaining unit 201 receives PDL data. A data processing unit 202 interprets the received PDL data and generates raster-format image data. The data processing unit 202 stores information about the PDL data and information about printing results in the job history. A trouble diagnosis unit 203 narrows down candidates for corrective actions for trouble based on a diagnostic subject and job information. A display control unit 204 displays a corrective action candidate(s) on the operation unit 115. A corrective action is displayed on the operation unit 115 based on a selected corrective action candidate. A job control unit 205 transmits the PDL data received by the data obtaining unit 201 to the data processing unit 202, and transfers the raster-format image data generated by the data processing unit 202 to the printer 118 to perform printing.

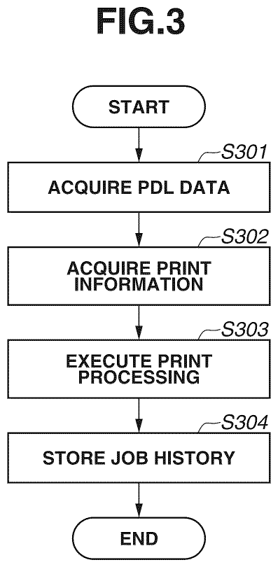

FIG. 3 is a flowchart illustrating a process to be performed by the CPU, from the acquisition of PDL data through the execution of print processing to the storing of job history. In step S301, the data obtaining unit 201 receives PDL data via the network I/F 116 under the control of the CPU 110. Alternatively, PDL data may also be obtained from the storage unit 113 of the image forming apparatus 100, where the PDL data has been temporarily stored. In step S302, the data obtaining unit 201 obtains print information. The print information refers to information relating to obtained PDL data. The print information includes information necessary for processing PDL data for printing and information to be stored in the job history. For example, the print information refers to information about the operating system (OS), driver, and application that have been used to generate PDL data, as well as driver setting information, such as a sheet size, a sheet type, and a page layout. Furthermore, the print information also refers to information about settings of the image forming apparatus 100, such as halftone and/or thickness adjustment, stored in the storage unit 113 of the image forming apparatus 100.

A process of obtaining print information will be described. PDL data is parsed to obtain the print settings embedded in the PDL data. Alternatively, the print settings stored in the storage unit 113 of the image forming apparatus 100 are obtained.

There are several methods for obtaining information about the OS and application used to generate PDL data. One method is obtaining information about the OS and application embedded in the PDL data from the PDL data. Another method is obtaining information about the OS and application separately from the PDL data via the network I/F 116.

In step S303, the data processing unit 202 executes print processing under the control of the CPU 110.

In the print processing, the obtained PDL data is initially parsed and intermediate data is generated for each page. Next, an image formation process is executed in which Raster Image Processor (RIP) processing is executed based on the generated intermediate data to convert the intermediate data into a raster-format image. Subsequently, the CPU 110 performs image processing on the raster-format image, and the printer 118 prints, on a recording medium, the rasterized image having been subjected to the image processing. In step S304, the data processing unit 202 executes job history storage processing under the control of the CPU 110. In the job history storage processing, information relating to the PDL data for which the printing processing has been executed is stored in the storage unit 113 as the job history. The data processing unit 202 stores the newly created job history along with past job history records in a job history database (DB) constructed by the data processing unit 202 in the storage unit 113. The job history of a job for which an execution command has been issued but has not been completed due to an error is also stored in the job history DB.

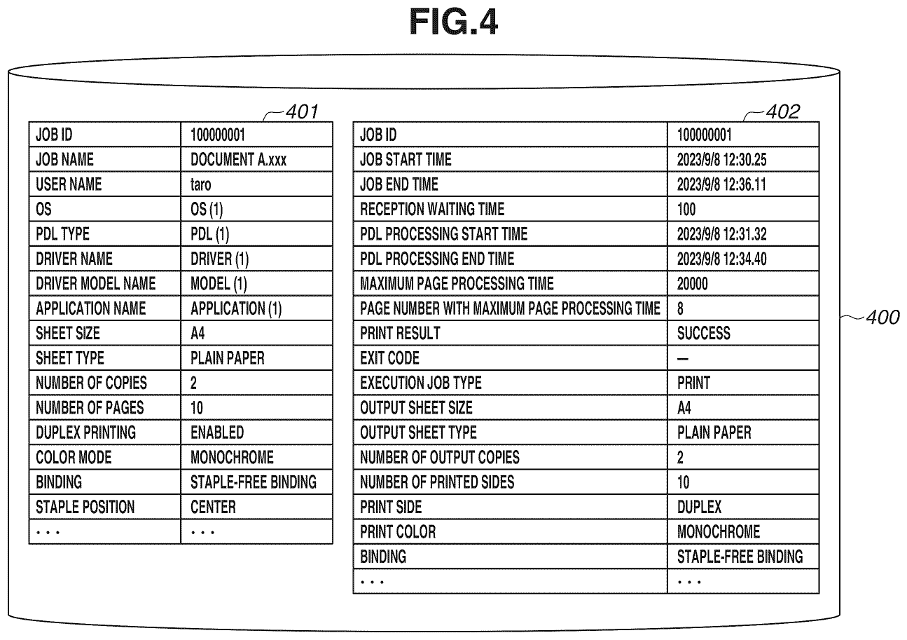

FIG. 4 illustrates examples of a job history DB and job history. Specifically, FIG. 4 illustrates examples of a job history DB 400, a job setting log 401, and a job execution log 402. The job setting log 401 stores information about PDL data and the like, and the job execution log 402 stores a print result and the like. Specific items in the job setting log 401 are described below.

“JOB ID” is a unique value that identifies a job. For the same job, the job ID in the job execution log 402 will be the same value.

“JOB NAME” represents the name of the printed file.

“USER NAME” represents the name of the user who has executed the printing.

“OS” refers to the name of the OS of the terminal used by the user to execute the printing.

“PDL TYPE” represents the type of the PDL data.

“DRIVER NAME” refers to the name of the driver used for printing. In a case where the direct printing is performed and the driver is not used, “-” is set.

“DRIVER MODEL NAME” refers to the name of a printer model for which the PDL driver used for printing is configured.

“APPLICATION NAME” refers to the name of the application used for the print execution.

“SHEET SIZE” refers to a sheet size, such as A4, B4, or a postcard.

“SHEET TYPE” refers to a sheet type, such as plain paper, thick paper, or an envelope.

“NUMBER OF COPIES” refers to the total number of prints of the same document.

“NUMBER OF PAGES” refers to the number of pages in the PDL data.

“DUPLEX PRINTING” refers to the setting that enables or disables duplex printing.

“COLOR MODE” refers to a color setting including color, monochrome, and automatic.

“BINDING” refers to the binding settings, such as stapling (with staples), staple-free binding, and other binding methods.

Specific items of the job execution log 402 are described below.

“JOB ID” is a unique value that identifies a job

“JOB START TIME” is the start time of the print processing.

“JOB END TIME” is the end time of the print processing.

“RECEPTION WAITING TIME” is the total duration of interruptions in the reception of PDL data.

“PDL PROCESSING START TIME” is the time either when PDL data parsing starts or when RIP processing starts.

“PDL PROCESSING END TIME” is the time either when PDL data parsing ends or when RIP processing ends.

“MAXIMUM PAGE PROCESSING TIME” is the longest time taken for PDL data parsing or RIP processing among the times measured for the individual pages.

“PAGE NUMBER WITH THE MAXIMUM PAGE PROCESSING TIME” is the page number that takes the longest time for PDL data parsing or RIP processing.

“PRINT RESULT” refers to a result of the printing processing. The value is “Success” when the printing processing completes successfully, and “Fail” when it terminates abnormally.

“EXIT CODE” is an identification number used to check an error message in a case where the print result is “Fail”. If the print result is successful, the exit code is set to

“EXECUTION JOB TYPE” represents the category of the job, such as FAX, copy, print, or scan.

“OUTPUT SHEET SIZE” refers to the size of a printed sheet, such as A4, B4, or a postcard.

“OUTPUT SHEET TYPE” refers to the sheet type of the printed sheet, such as plain paper, thick paper, or an envelope.

“NUMBER OF OUTPUT COPIES” refers to the total number of printed copies of the same document

“NUMBER OF PRINTED SIDES” refers to the number of sides printed on the print sheets.

“PRINT SIDE” refers to whether duplex printing has been applied to the output sheet(s).

“PRINT COLOR” refers to the color used for printing on the output sheet(s).

“BINDING METHOD” refers to the type of binding process applied to the output sheets, such as stapling (with staples), staple-free binding, or other binding methods.

The items to be stored in the job history DB described here are merely examples and are not limited to these. The job history DB 400 accumulates a job history record for each job and is used for displaying job history and diagnosing printing trouble, among other uses.

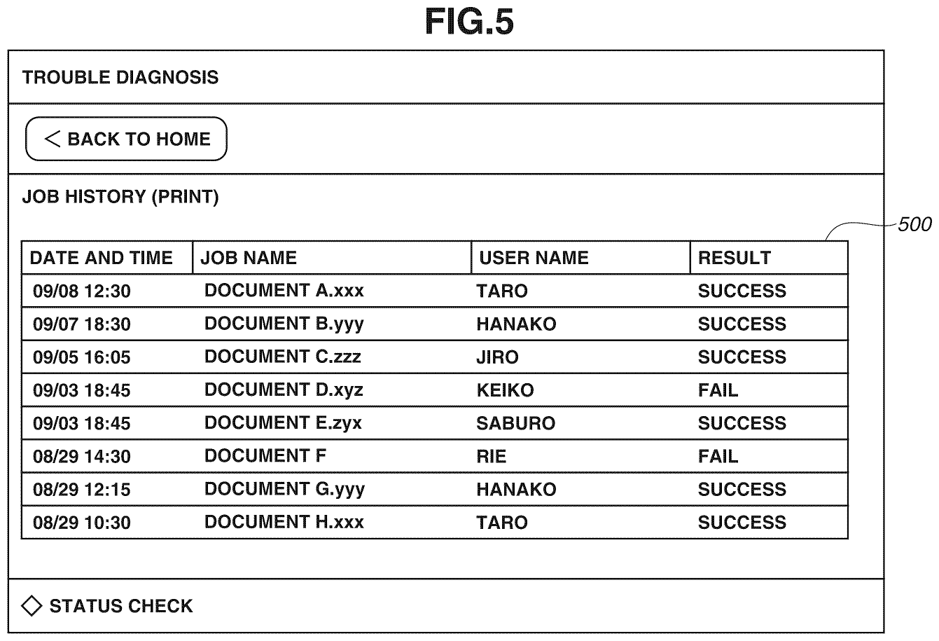

FIG. 5 is a diagram illustrating a display example of job history displayed on the operation unit 115. A job history display section 500 displays job information entries of jobs from the jobs in the job execution logs 402, arranged in descending order of start times with the newest at the top. The job history display section 500 displays job information entries for the corresponding jobs in an organized manner.

The image forming apparatus 100 according to the present exemplary embodiment is capable of user authentication. Users can log in using touch authentication with an IC card or by using an authentication method combining a username and password. The image forming apparatus 100 can recognize the user who is currently logged in using any of these authentication methods. The job information displayed in the job history display section 500 illustrated in FIG. 5 may vary depending on the currently logged-in user. The job information about jobs that the currently logged-in user has executed (or issued execution commands for) are displayed, allowing the user to view the job information related to the user.

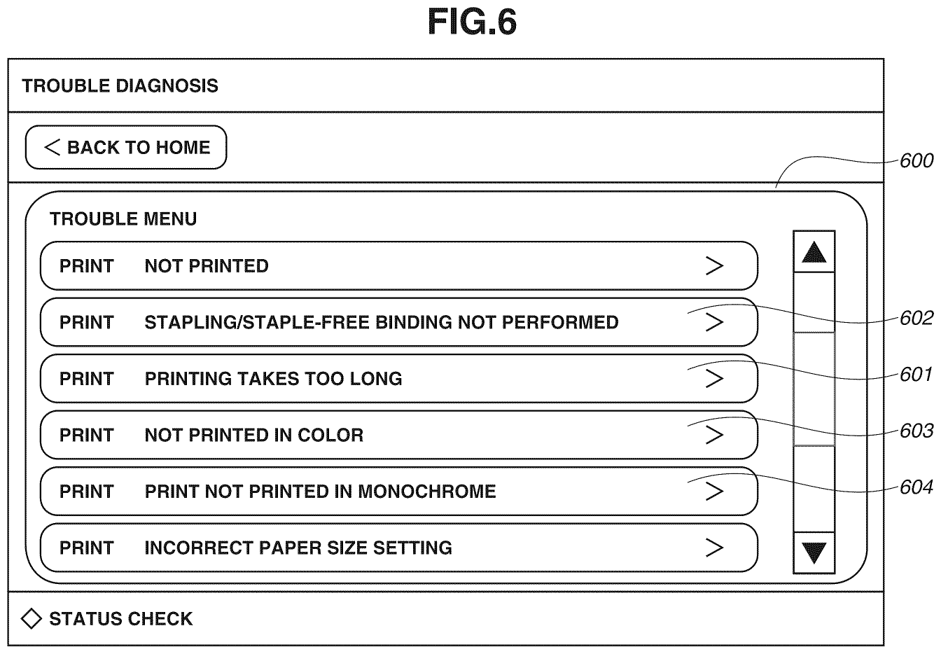

FIG. 6 is a diagram illustrating an example of a top menu for diagnosing a job in which trouble has occurred. A trouble menu 600 displays diagnostic subjects and serves as a screen for receiving the selection of a diagnostic subject.

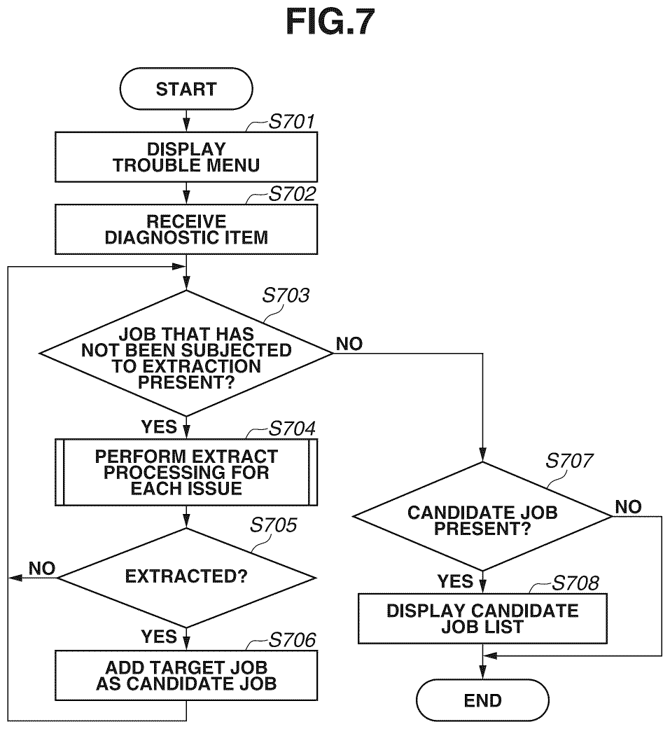

Here, as an example, a candidate job display process will be described with reference to FIG. 6 to FIG. 9 in a case where a “Printing Takes Too Long” item 601 under the “Print” function is selected. FIG. 7 is a flowchart illustrating a process for displaying candidate jobs to be performed by the CPU 110.

In step S701, the trouble diagnosis unit 203 displays the trouble menu 600 illustrated in FIG. 6, under the control of the CPU 110.

In step S702, in response to the trouble diagnosis unit 203 receiving the selection of the “Printing Takes Too Long” item 601, the processing proceeds to step S703. In step S703, the trouble diagnosis unit 203 initially obtains information from the job history DB and checks whether there are any jobs for which the extraction process has not been performed. If there are any jobs that have not been subjected to the extraction process (YES, in step S703), the processing proceeds to S704. If all the jobs have been subjected to the extraction process (NO, in step S703), the processing proceeds to step S707. Additionally, immediately after the complete deletion of the job history, or if the image forming apparatus 100 is in a factory-default state, the job history will be empty. In such cases, the processing proceeds to step S707.

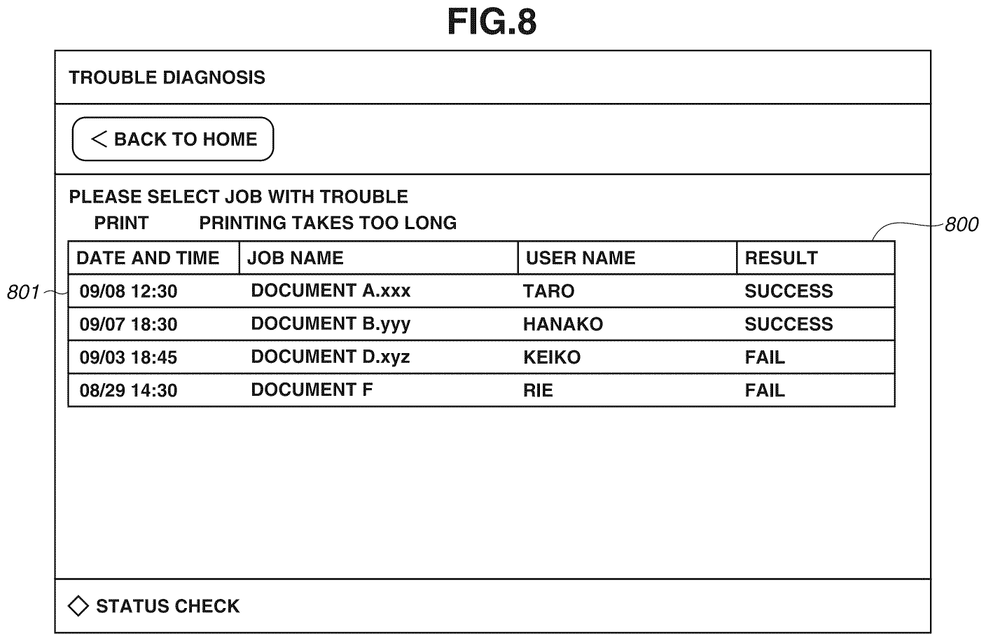

In step S704, processing specific to each issue is performed, and the processing proceeds to step S705. If the “Printing Takes Too Long” item 601 is selected as an issue, the extraction process illustrated in FIG. 7 is executed. In step S705, the trouble diagnosis unit 203 determines whether a job ID has been stored in the return value from the issue-specific processing in step S704. If a job ID has been stored (YES, in step S705), the processing proceeds to step S706. If no job ID has been stored (NO, in step S705), the processing returns to step S703. In step S706, the trouble diagnosis unit 203 adds the job corresponding to the job ID stored in the return value as a candidate job. In step S707, the trouble diagnosis unit 203 checks whether there are any candidate jobs that meet a condition(s). If any candidate jobs that meet the condition(s) are present (YES, in step S707), the processing proceeds to step S708. In step S708, the candidate job(s) is/are displayed in a candidate job list 800 illustrated in FIG. 8 on the operation unit 115. If no candidate jobs that meet the condition(s) are present (NO, in step S707), there are no jobs to display, so that no display is performed, and the processing is ended.

The candidate job list illustrated in FIG. 8 displays job information entries for the jobs extracted as candidate jobs through the extraction process. In FIG. 8, each job information entry includes the job name, the username of the user who has executed the job, and the date and time of the job execution. The displayed job information may be limited to only the job information related to the currently logged-in user among the candidate jobs. When a diagnostic subject is received in step S702, the screen transitions from the screen displaying the diagnostic subjects to the screen displaying the candidate job list illustrated in FIG. 8.

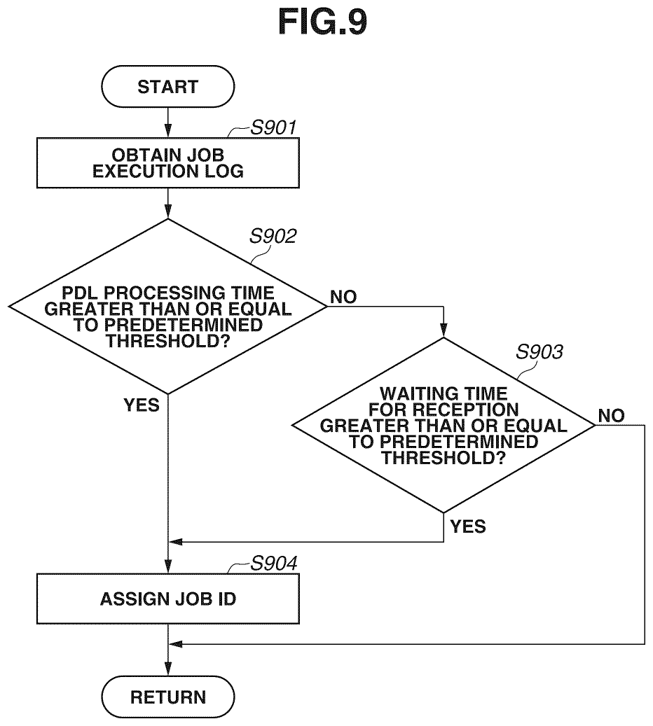

FIG. 9 is a flowchart illustrating a candidate job extraction process to be performed by the CPU 110 in a case where the “Printing Takes Too Long” item 601 is selected as an issue. In step S901, under the control of the CPU 110, the trouble diagnosis unit 203 retrieves one job execution log 402 that has not yet been obtained, from the job history DB 400, and the processing proceeds to step S902. In step S902, the trouble diagnosis unit 203 calculates the duration from the start time to the end time of the PDL processing, and determines whether this duration is greater than or equal to a predetermined threshold (e.g., 5 minutes). If the duration is greater than or equal to the predetermined threshold (YES, in step S902), the processing proceeds to step S904. If the duration is less than the predetermined threshold (NO, in step S902), the processing proceeds to step S903. In step S903, the trouble diagnosis unit 203 determines whether a reception waiting time is equal to or greater than a predetermined threshold (e.g., 10 minutes). If the trouble diagnosis unit 203 determines that the reception waiting time is equal to or greater than the predetermined threshold (YES, in step S903), the processing proceeds to step S904. If the trouble diagnosis unit 203 determines that the reception waiting time is less than the predetermined threshold (NO, in step S903), the processing is ended and is returned to the process in the flowchart in FIG. 7. In step S904, the trouble diagnosis unit 203 assigns the job ID that meets any of the extraction conditions to the return value. The processing is then ended and is returned to the process in the flowchart in FIG. 7.

In a case where the selection of “Printing Takes Too Long” item 601 is received, the history of the candidate jobs obtained through the extraction as described above is displayed. The candidate job list 800 in FIG. 8 includes fewer job information entries than those in the job history display section 500 in FIG. 5 due to the extraction process. The narrowed-down job information entries correspond to the selected diagnostic subject, which is the “Printing Takes Too Long” item 601, thus enabling the user to easily find the job they wish to diagnose.

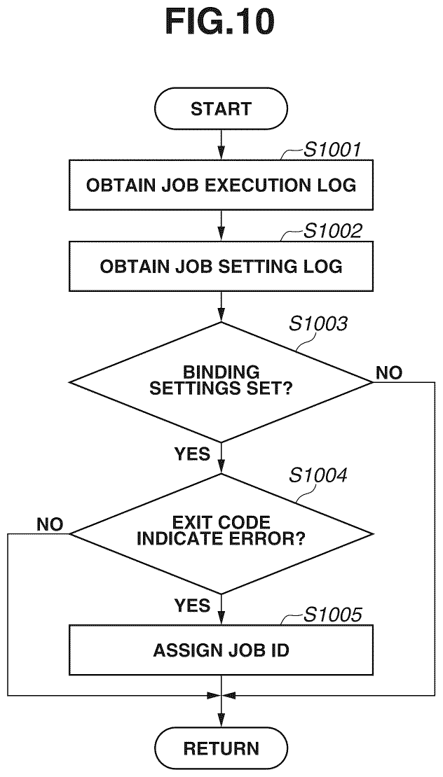

FIG. 10 is a flowchart illustrating a process of a candidate job extraction process to be performed by the CPU 110 in a case where a “Stapling/Staple-Free Binding Not Performed” item 602 is selected as an issue. In step S1001, under the control of the CPU 110, the trouble diagnosis unit 203 retrieves one job execution log 402 that has not been obtained yet from the job history DB 400, and the processing proceeds to step S1002. In step S1002, the trouble diagnosis unit 203 retrieves one job setting log 401 corresponding to the job execution log 402 retrieved in step S1001 from the job history DB 400. The processing then proceeds to S1003. In step S1003, the trouble diagnosis unit 203 determines whether the binding settings in the job setting log 401 indicate stapling (with staples), staple-free stapling, or other binding methods. If any binding method is specified (YES, in step S1003), the processing proceeds to step S1004. If binding is not specified (NO, in step S1003), the processing is ended and is returned to the process of the flowchart in FIG. 7. In step S1004, the trouble diagnosis unit 203 determines whether the exit code in the job execution log 402 is a value indicating an error. If the trouble diagnosis unit 203 determines that the exit code indicates a value indicating an error (YES, in step S1004), the processing proceeds to step S1005. If the trouble diagnosis unit 203 determines that the exit code indicates a value indicating a successful completion (NO, in step S1004), the processing is ended and is returned to the process of the flowchart in FIG. 7. In step S1005, the trouble diagnosis unit 203 assigns the job ID that meets the extraction conditions to the return value. The processing is then ended and is returned to the process of the flowchart in FIG. 7.

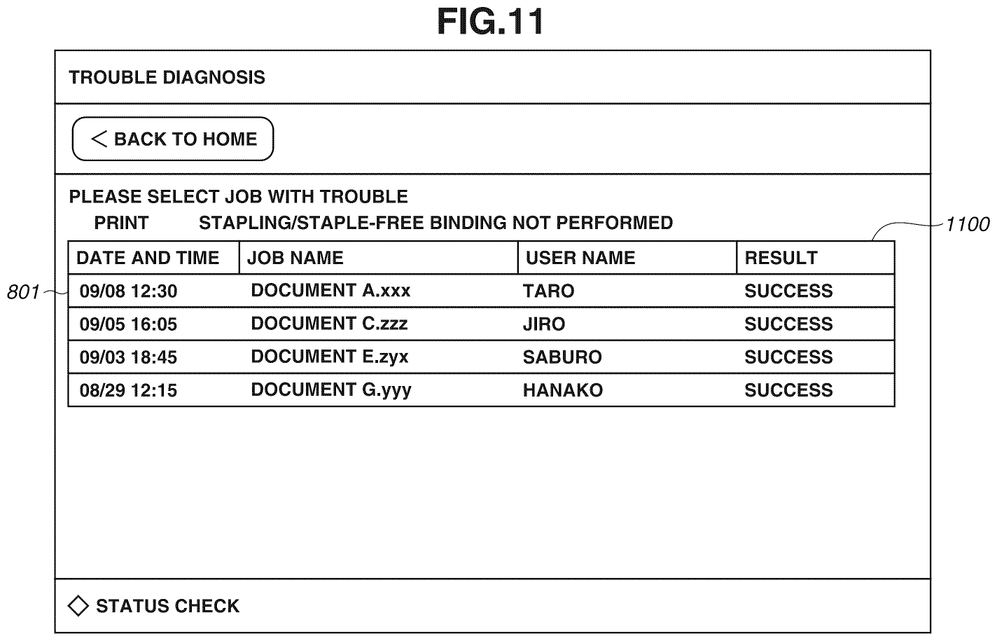

FIG. 11 is an example of a candidate job list 1100 displayed in the operation unit 115 in a case where the “Stapling/Staple-Free Binding Not Performed” item 602 is selected as an issue. In a case where the “Stapling/Staple-Free Binding Not Performed” 602 as a diagnosis subject is received, it is assumed that the user has set the binding settings enabled. Thus, the history of the candidate jobs obtained through the extraction as described above is displayed. The candidate job list 1100 illustrated in FIG. 11 includes fewer job information entries than those in the job history display section 500 in FIG. 5 due to the extraction process. The narrowed-down job information entries correspond to the selected diagnostic subject, which is the “Stapling/Staple-Free Binding Not Performed” item 602, thus enabling the user to easily find the job they wish to diagnose.

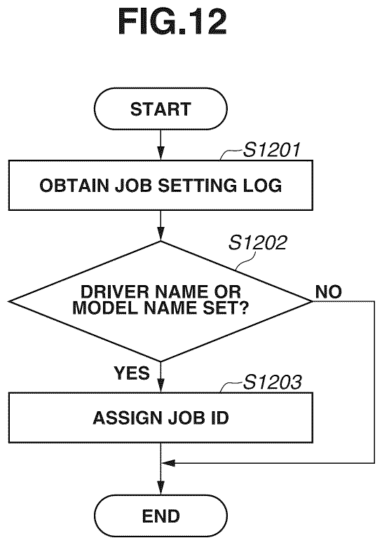

FIG. 12 is a flowchart illustrating a candidate job extraction process to be performed by the CPU 110 in a case where a “Not Printed in Color” item 603 or a “Not Printed in Monochrome” item 604 is selected as an issue. In step S1201, under the control of the CPU 110, the trouble diagnosis unit 203 retrieves one job setting log 401 that has not yet been obtained from the job history DB 400, and the processing proceeds to step S1202. In step S1202, the trouble diagnosis unit 203 determines whether either the driver name or the driver model name is set in the job setting log 401. If the trouble diagnosis unit 203 determines that either the driver name or the driver model name is set (YES, in step S1202), the processing proceeds to step S1203. If neither is set (NO, in step S1202), the processing is ended and is returned to the process of the flowchart in FIG. 7. In step S1203, the trouble diagnosis unit 203 assigns the job ID that meets the extraction condition to the return value. The processing is then ended and is returned to the process in FIG. 7.

The occurrence of an issue such as “Not Printed in Color” or “Not Printed in Monochrome” is often caused by an incorrect printer driver or an incorrect model selection in the driver. Thus, the history for the candidate jobs obtained through the extraction as described above is displayed. Although not illustrated, the number of the job information entries displayed on the operation unit 115 is reduced compared with that in the job history display section 500 in FIG. 5. Thus, the user can easily find the target job.

Additionally, a job for which the corresponding items in the job setting log 401 and the job execution log 402 do not match may be extracted as a candidate job to display the job history thereof. For example, this applies to cases where, with the “Stapling/Staple-Free Binding Not Performed” item 602 selected as an issue, stapling is specified in the binding settings in the job setting log 401 but an item indicating a stapling process in the job execution log 402 indicates that stapling has not been performed.

Alternatively, in a case where the “Printing Takes Too Long” item 601 is selected as an issue, the job history of the candidate jobs may be displayed in descending order of the time taken for reception or PDL processing.

In the candidate job list 800, only the extracted candidate jobs are displayed. Alternatively, non-candidate jobs may be displayed in a grayed-out state, allowing only the extracted candidate jobs to be selected.

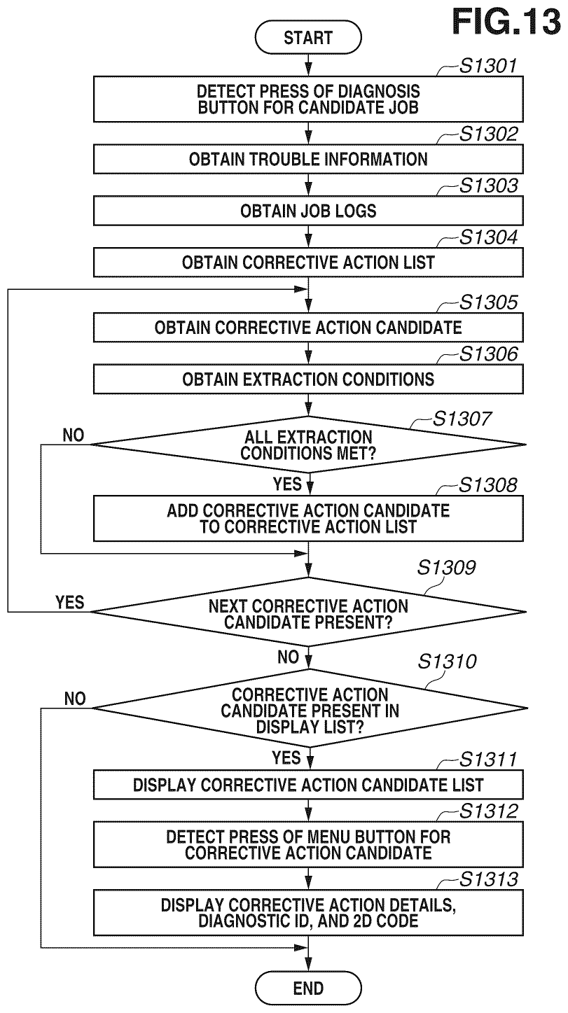

Next, the display of corrective actions when trouble diagnosis is performed will be described, taking the case where the “Printing Takes Too Long” item 601, which is a diagnostic subject, and a job information entry 801 are selected as an example, with reference to FIG. 13 to FIG. 16.

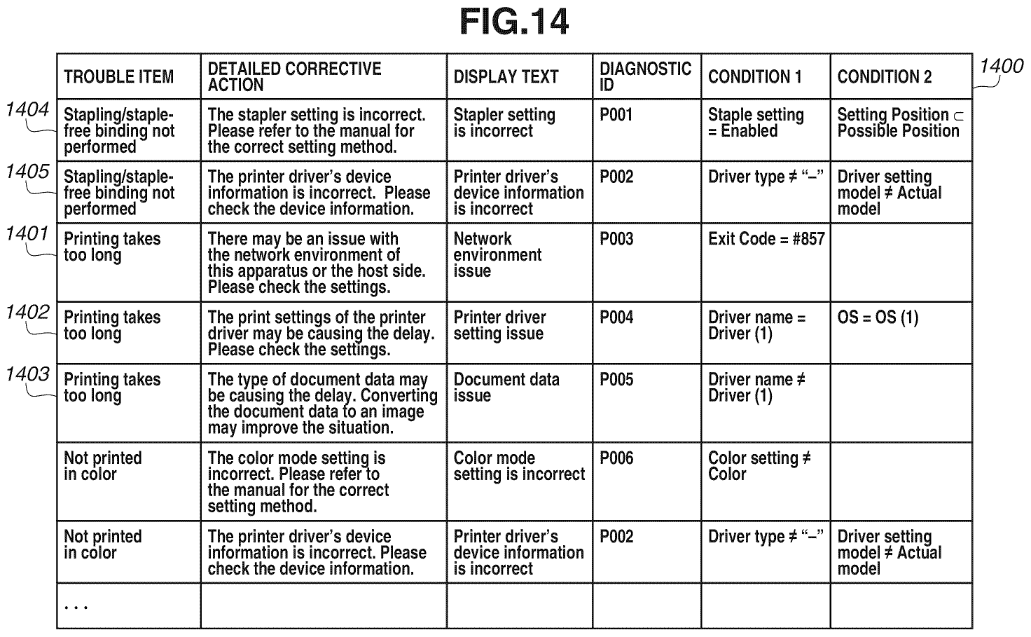

FIG. 13 is a flowchart illustrating a process in which the CPU 110 causes the trouble diagnosis unit 203 to narrow down corrective actions to be displayed in diagnostic results, based on the selected diagnostic subject (item) and job information entry. In step S1301, after the selection of “Printing Takes Too Long” item 601, the trouble diagnosis unit 203 receives a selection of the job information entry 801, under the control of the CPU 110. Then, in step S1302, the trouble diagnosis unit 203 obtains the diagnostic subject. Here, “Printing Takes Too Long” is obtained as the diagnostic subject. Next, in step S1303, the trouble diagnosis unit 203 retrieves the job logs corresponding to the selected job information entry. Specifically, the job setting log 401 and job execution log 402 corresponding to the job information entry 801 are obtained. In step S1304, the trouble diagnosis unit 203 obtains a corrective action list 1400 illustrated in FIG. 14. Then, in step S1305, the trouble diagnosis unit 203 obtains one corrective action candidate from the corrective action list 1400. In step S1306, the trouble diagnosis unit 203 obtains the extraction condition(s) for determination as to whether the obtained corrective action candidate is to be extracted as a corrective action candidate. In step S1307, the trouble diagnosis unit 203 checks whether one or more values included in the obtained job setting log 401 and job execution log 402 meets the extraction conditions. If the value(s) meets/meet all the condition(s) (YES, in step S1307), the processing proceeds to step S1308. In step S1308, the trouble diagnosis unit 203 adds the corrective action candidate that meets the extraction condition(s) to a display list. The processing then proceeds to step S1309. If no condition(s) is/are met (NO, in step S1307), the processing proceeds to step S1309. In step S1309, the trouble diagnosis unit 203 checks whether there are any unprocessed corrective action candidates. If there are any unprocessed corrective action candidates (YES, in step S1309), the processing returns to step S1305 to retrieve a new corrective action candidate and the operations from step S1306 to step S1308 are repeated. If there are no remaining unprocessed corrective action candidates (NO, in step S1309), the processing proceeds to step S1310.

In a case where the “Printing Takes Too Long” item 601 is selected as the diagnostic subject, a trouble items 1401 to 1403 qualifies as a corrective action candidate, among the trouble items in the corrective action list 1400. A value(s) in the job setting log 401 and job execution log 402 is/are compared with the extraction conditions of the trouble items 1401 to 1403. For the trouble item 1401 with the display text string “Network environment issue”, the extraction condition is that the exit code equals #857. In the job execution log 402, the exit code is “-”, which does not meet the condition, so this corrective action candidate is not added to the display list. For the trouble item 1402 with the display text string “Printer driver setting issue”, the extraction conditions are that the driver name is “Driver (1)” and that the OS is “OS (1)”. In the job setting log 401, the driver is “Driver (1)” and the OS is “OS (1)”, which meet the conditions. Thus, this corrective action candidate is added to the display list. For the trouble item 1403 with the display text string “Document data issue”, the extraction condition is that the driver is not “Driver (1)”. In the job setting log 401, the driver is “Driver (1)”, which does not meet this condition. Thus, this corrective action candidate is not added to the display list. As a result, only the corrective action candidate corresponding to the trouble item 1402 is added to the display list.

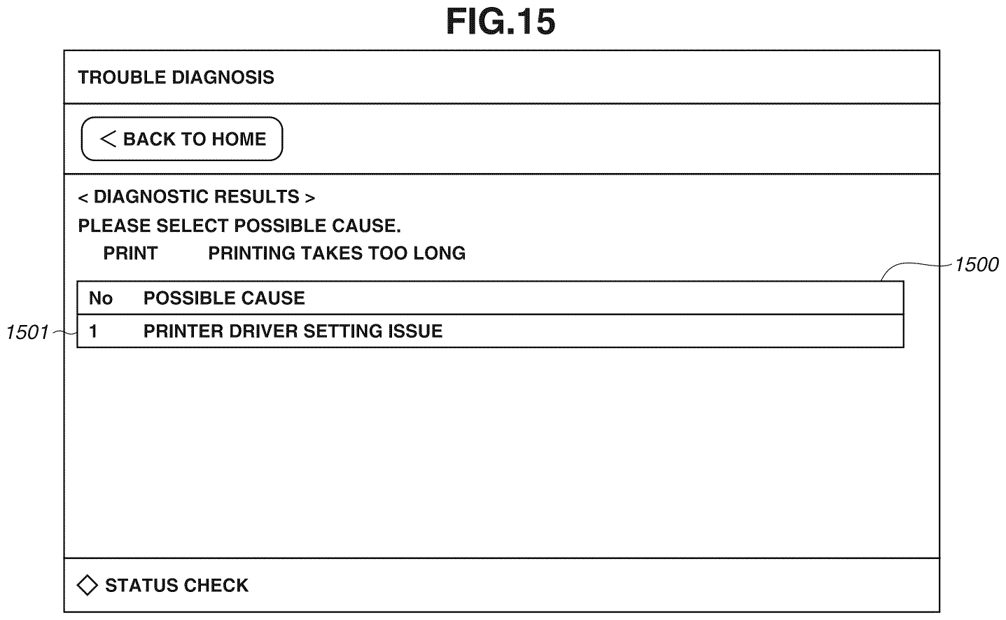

In step S1310, the trouble diagnosis unit 203 checks whether there are any corrective action candidates in the display list. If there are any corrective action candidates (YES, in step S1310), the processing proceeds to step S1311. In step S1311, the trouble diagnosis unit 203 displays diagnostic results, as illustrated in FIG. 15, on the operation unit 115. The diagnostic results include a corrective action candidate list 1500, in which the corrective action candidate(s) is/are listed.

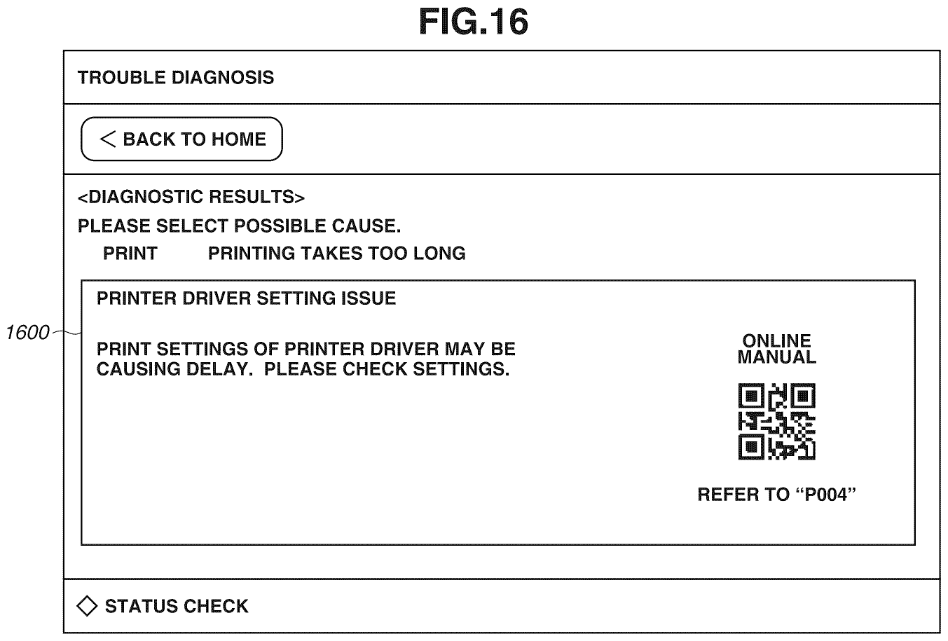

In step S1312, in response to the detection of the press of a menu button for “Printer Driver Settings Issue” 1501, which is one of the corrective action candidates in FIG. 15, the processing proceeds to step S1313. In step S1313, the trouble diagnosis unit 203 displays detailed information about the selected corrective action in a corrective action detail display unit 1600 illustrated in FIG. 16. Specifically, the trouble diagnosis unit 203 displays the display text string “Printer Driver Setting Issue” and the diagnostic ID both of which correspond to the trouble item 1402 as illustrated in FIG. 14, as well as a two-dimensional code indicating the Uniform Resource Locator (URL) of the online manual for the image forming apparatus 100.

Here, an example has been provided in which a corrective action candidate is extracted when the “Printing Takes Too Long” item 601 and the job information entry 801 are selected. However, a similar method for extracting corrective action candidates applies to cases where a combination of other trouble (diagnostic subject) and another job information entry is selected. For example, in a case where the “Stapling/Staple-Free Binding Not Performed” item 602 and the job information entry 801 are selected, the trouble diagnosis unit 203 compares information from the job logs corresponding to the selected job information entry 801 with the extraction conditions of the trouble items 1404 and 1405, which correspond to “Stapling/Staple-Free Binding Not Performed” in the corrective action list 1400, thereby extracting the relevant corrective action candidates. Specifically, information in the job setting log 401 and job execution log 402 corresponding to the job information entry 801 is compared with the extraction conditions, and ultimately, corrective action candidates, including those corresponding to the trouble item 1404, are added to the display list and displayed. Thus, when the “Stapling/Staple-Free Binding Not Performed” item 602 is selected, only the corrective action candidates related to “Stapling/Staple-Free Binding Not Performed” and the selected job are displayed.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-084792, filed May 24, 2024, which is hereby incorporated by reference herein in its entirety.

What is claimed is:

1. An information processing apparatus, comprising
a display;
one or more memories storing instructions, and
one or more processors capable of executing the instructions causing the information processing apparatus to:
receive a selection of a diagnostic subject;
display, on the display, at least one piece of job information based on the received diagnostic subject from a plurality of pieces of information related to jobs executed by the information processing apparatus;
receive a designation based on the at least one piece of job information displayed; and
perform a diagnosis of the information processing apparatus using the received diagnostic subject and a piece of job information corresponding to the designation.

2. The information processing apparatus according to claim 1, wherein a result of the diagnosis is displayed on the display.

3. The information processing apparatus according to claim 1, further comprising a printing apparatus configured to perform printing.

4. The information processing apparatus according to claim 3, wherein, in a case where a job corresponding to the designation is a print job to be executed by the printing apparatus, the diagnosis is executed using information about the printing apparatus.

5. The information processing apparatus according to claim 1, wherein the plurality of pieces of job information related to the one or more jobs executed by the information processing apparatus is execution history of the one or more job.

6. The information processing apparatus according to claim 1, wherein, in a case where a user is authenticated, the at least one piece of job information displayed on the display is job information about the authenticated user.

7. A method in an information processing apparatus including a display, the method comprising:
receiving a selection of a diagnostic subject;
displaying, on the display, at least one piece of job information based on the received diagnostic subject from a plurality of pieces of information related to jobs executed by the information processing apparatus;
receiving a designation based on the at least one piece of job information displayed; and
performing a diagnosis of the information processing apparatus using the received diagnostic subject and a piece of job information corresponding to the designation.
